(19) United States
(12) Patent Application Publication
(10) Pub. No.: US 2013/0138481 A1
(43) Pub. Date: May 30, 2013

(54) DETECTING PARKING ENFORCEMENT OPPORTUNITIES

(71) Applicant: John C. Handley, Roselawn, NY (US)

(72) Inventor: John C. Handley, Roselawn, NY (US)

(73) Assignee: XEROX CORPORATION, NORWALK, CT (US)

(21) Appl. No.: 13/304,932

(22) Filed: Nov. 28, 2011

(51) Int. Cl. G06Q 10/04; G06Q 50/26

(52) U.S. Cl. 705/7.37

(57) ABSTRACT

Methods and systems automatically analyze different types of historical automobile parking violations within a predetermined geographic region to produce parking violation trends. Such methods and systems automatically predict the numbers of parking violations that potentially could be issued during a plurality of predetermined work periods based on the parking violation trends. The methods and systems automatically compare the actual number of parking violations issued during the predetermined work periods to the number of parking violations that potentially could be issued during the predetermined work periods to produce a parking violation issuance variance. The methods and systems also automatically identify ones of the predetermined work periods in which parking violation citations could be increased to produce an opportunity report, and output the opportunity report.

### BACKGROUND

Embodiments herein generally relate to methods and systems used for parking enforcement and more particularly, to systems and methods that automatically identify time periods in which parking violation citations could be increased.

Parking fines are an important source of revenue for major cities. Therefore, conventional software programs are utilized to capture parking violation statistics including who wrote the ticket, the time of day, the violation type, and the fine amount. Interesting and useful statistics can be generated, such as which parking enforcement officer is the most productive, revenue trends and the like.

Handicap parking violations are a large revenue source. In one example, there were 769 Handicap Parking violations, which accounted for 7% ($385,000) of the total $4,900,000 in revenue (141,000 citations). One reason for such disproportionate results is that a Handicap Parking violation earns the perpetrator a $500 fine (compared to an average fine of $36). Handicap Parking violations are lucrative, but enforcement also carries a great deal of social good, to protect the accessibility of the disabled.

### SUMMARY

An exemplary computer-implemented method herein automatically analyzes different types of historical automobile parking violations within a predetermined geographic region using a computerized device to produce parking violation trends. This method automatically predicts the number of parking violations that potentially could be issued during a plurality of predetermined work periods based on the parking violation trends (using the computerized device). The method automatically compares the actual number of parking violations issued during the predetermined work periods to the number of parking violations that potentially could be issued during the predetermined work periods, using the computerized device, to produce a parking violation issuance variance. This method also automatically identifies ones of the predetermined work periods in which parking violation citations could be increased (using the computerized device) to produce an opportunity report, and outputs the opportunity report from the computerized device.

For example, the predetermined work periods can comprise a portion of a work day (hourly), a work day (daily), a work week (weekly), a work month (monthly), and a work year (annually). Further, the parking violation trends are specific to each different geographic region. Also, the historical automobile parking violations can comprise only parking violation citations issued by a parking enforcement division, or can comprise observed violations of parking regulations (independent of the parking violation citations issued by a parking enforcement division) or some combination of the two.

Another computer-implemented method herein automatically analyzes historical automobile parking violations within the predetermined geographic region using the computerized device to produce parking violation trends. This method also automatically predicts the number of parking violations that potentially could be issued by at least one parking official during at least one predetermined work period based on the parking violation trends (using the computerized device). This method then automatically compares the actual number of parking violations issued by the parking official during the predetermined work period to the number of parking violations that potentially could be issued by the parking official during the predetermined work period (using the computerized device) to produce a parking violation issuance variance for the parking official(s). This method then outputs the parking violation issuance variance from the computerized device.

A system embodiment herein includes a plurality of automobile parking violation enforcement devices producing parking violation information. Further, a communications device is operatively connected to the parking violation enforcement devices. The communications device aggregates different types of the parking violation information into historical automobile parking violations. A processor is operatively connected to the communications device.

The processor automatically analyzes the historical automobile parking violations within the predetermined geographic region to produce parking violation trends. The processor automatically predicts the numbers of parking violations that potentially could be issued during the plurality of predetermined work periods based on the parking violation trends. The processor automatically compares the actual number of parking violations issued during the predetermined work periods to the number of parking violations that potentially could be issued during the predetermined work periods to produce a parking violation issuance variance, and the processor automatically identifies ones of the predetermined work periods in which parking violation citations could be increased to produce an opportunity report. An input/output device is operatively connected to the processor, and the input/output device outputs the opportunity report.

Another system herein similarly comprises the plurality of automobile parking violation enforcement devices producing parking violation information, and the communications device operatively connected to the parking violation enforcement devices. The communications device again aggregates different types of the parking violation information into historical automobile parking violations. Here also the processor is operatively connected to the communications device.

The processor again automatically analyzes historical automobile parking violations within a predetermined geographic region to produce parking violation trends. Here, the processor automatically predicts the number of parking violations that potentially could be issued by at least one parking official during at least one predetermined work period based on the parking violation trends, and this processor automatically compares the actual number of parking violations issued by the parking official during the predetermined work period to the number of parking violations that potentially could be issued by the parking official during the predetermined work period to produce a parking violation issuance variance for the parking official. The input/output device here is also operatively connected to the processor. The input/output device outputs the parking violation issuance variance from the computerized device.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a table showing actual parking violation counts;

FIG. 2 is a plot of actual and predicted value of models used by embodiments herein;

FIG. 3 is an actual-projected table utilized by embodiments herein;

FIG. 4 is a significance tables utilized by embodiments herein;

FIG. 5 is a graph of hourly parking violation enforcement;

FIG. 6 is a graph of weekly parking violation enforcement;

FIG. 7 is a table showing actual parking violation counts;

FIG. 8 is a graph of hourly parking violation enforcement;

FIG. 9 is a graph of weekly parking violation enforcement;

FIG. 10 is a table showing actual parking violation counts;

FIG. 11 is flow diagram illustrating various embodiments herein;

FIG. 12 is flow diagram illustrating various embodiments herein;

FIG. 13 is schematic block diagram of a system according to embodiments herein;

FIG. 14 is schematic block diagram of a computerized device according to embodiments herein; and

FIG. 15 is schematic block diagram of a computerized device according to embodiments herein.

### DETAILED DESCRIPTION

As mentioned above, parking fines are an important source of revenue for major cities. Therefore, the embodiments herein provide a computational system by which information about which officer wrote a ticket for which kind of violation and when is analyzed to determine deficiencies in enforcement, and resources are directed to fill gaps, thus increasing revenue. For example, the systems and methods herein look for opportunity as a function of time. If there are times in the week when enforcement is lax, the systems and methods herein uncover that revenue-generating opportunity.

The systems and methods herein can accumulate a large amount of parking violation data, such as an entire year's worth of data. This allows random effects of time and badge enforcement differences to be integrated out. What remains is systematic or structural. Further up counts of enforcement should vary somewhat smoothly from hour to hour, weekday to weekday.

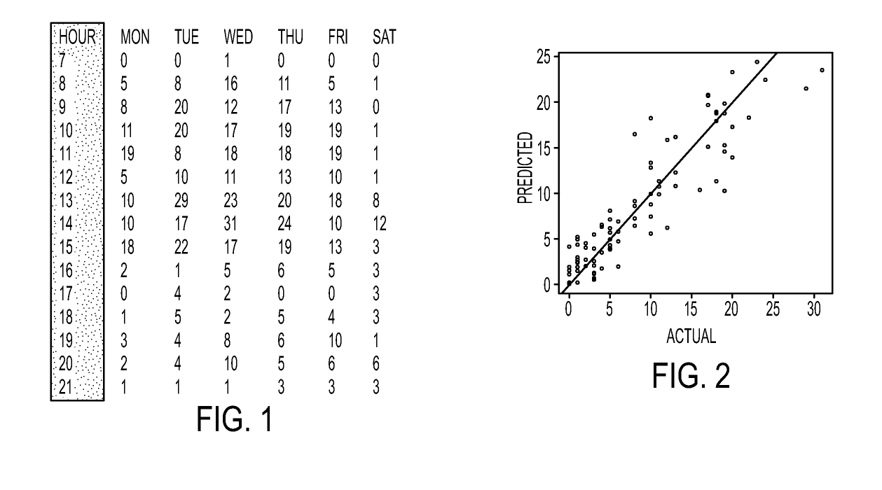

The table shown in FIG. 1 shows actual parking violation counts at different times of the day for a given week (Monday-Saturday). As shown in FIG. 1, there is a rough regularity of parking violations. The systems and methods herein determine systematic behavior about which there is some random variation. The systematic part of the models used by the systems and methods herein point to what is to be expected and significant deviations (deficiencies) from that indicate opportunities.

The number of violations has been found to follow a Poisson distribution as a function of hour of the day and day of the week (there are no enforcements on Sunday in these data). One model used by systems and methods herein is a generalized linear model, shown below:

$$f ( {x}_{ij} ) = \frac{{e}^{- {μ}_{ij}} {μ}_{ij}^{{x}_{ij}}}{{x}_{ij} !} ; {x}_{ij} > 0$$

$$log ( {μ}_{ij} ) = {h}_{i} + {w}_{j}$$

$${μ}_{ij} = {e}^{{h}_{i}} {e}^{{w}_{j}}$$

Note, that in the foregoing model the rates of occurrence are separated into an hourly effect h and a week-daily effect w. The model is useful: (Residual deviance of 120 on 70 degrees of freedom; Chi-squared p-value=0.0002; the maximum Cook's distance is 0.12 so there are no influential points). Lack of fit is not due to structural issues i.e., systematic error is low. FIG. 2 shows a plot of actual and predicted value (means). The correlation is high (0.92) and there are no exceptional model mis-specification issues. If the fitted value is much less that the estimated value and it is significantly so (as indicated by the small p-value of its Pearson residual), this allows the systems and methods herein to identify an opportunity for stepped-up enforcement and revenue.

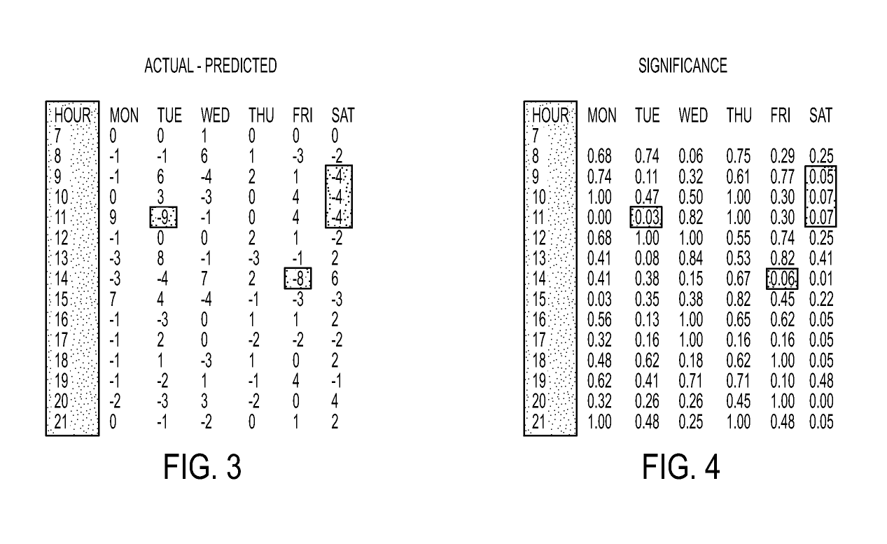

The actual-projected and significance tables shown in FIGS. 3 and 4 illustrate the significant lower-than-expected citation rates. For example, highlighted areas in the tables shown in FIG. 3 illustrate areas of increased enforcement. For example, as shown in FIGS. 3 and 4, Tuesdays at 11 represent a significant enforcement opportunity.

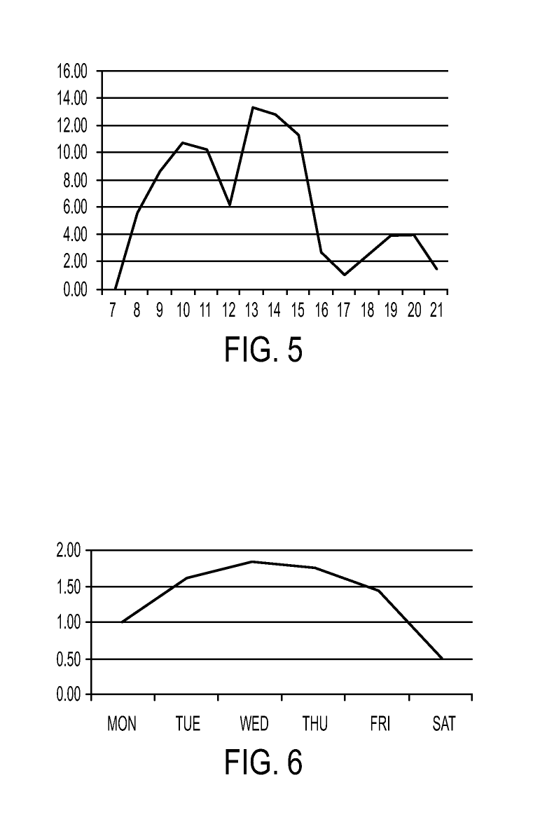

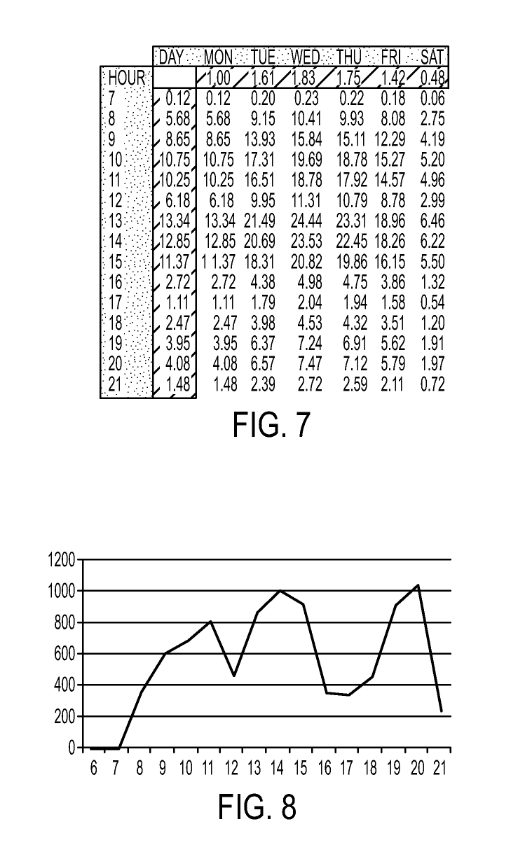

Further, the systems and methods herein look at the effects of the hour of day or day of the week on enforcement rates. FIG. 5 is a graph of hourly parking violation enforcement citations issued, FIG. 6 is a graph of weekly parking violation enforcement citations issued, and FIG. 7 is a table showing actual parking violation counts. The table in FIG. 7 shows the estimated rates (what should happen based on the model), with the contribution of each dimension shown. The weekly graphs of violations in FIG. 6 shows that enforcement peaks on Wednesdays, but across the week, enforcement is down at noon (as shown by the graph in FIG. 5) ostensibly due to officers taking lunch and at 5 pm, perhaps due to shift changes.

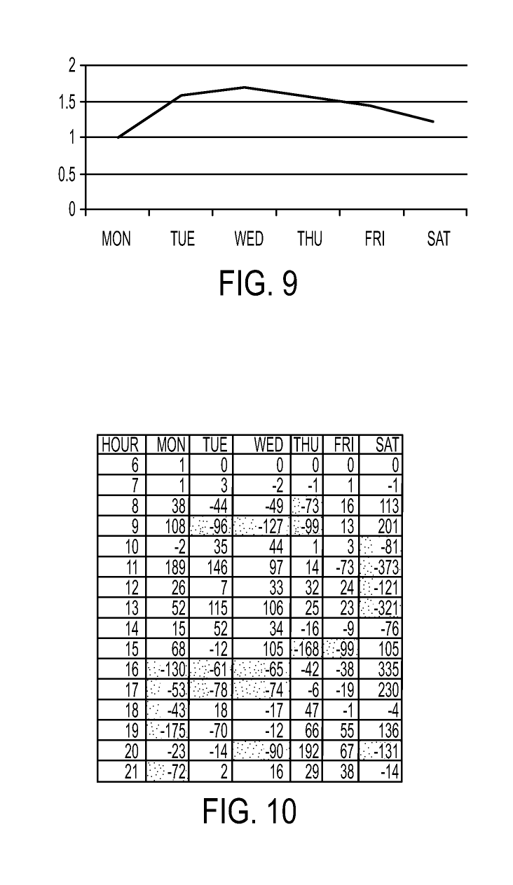

FIGS. 8-10 provide an analysis for overtime meter violations. FIG. 8 is a graph of hourly parking violation enforcement citations issued, FIG. 9 is a graph of weekly parking violation enforcement citations issued, and FIG. 10 is a table showing actual parking violation counts. As shown by FIGS. 8-10, Saturdays between 9 am and 12 Noon is an opportunity for increased enforcement, as is Monday 4 pm-7 pm.

Therefore, the systems and methods herein collect parking violations information by type and time, store information in a database, perform a statistical analysis of data to identify opportunities for enforcement by hour of day and day of week, and generate an operational directive to increase patrols or enforcement.

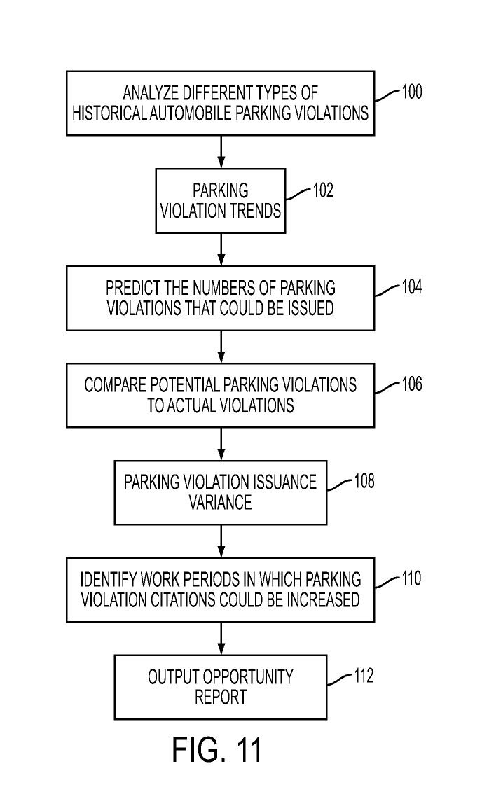

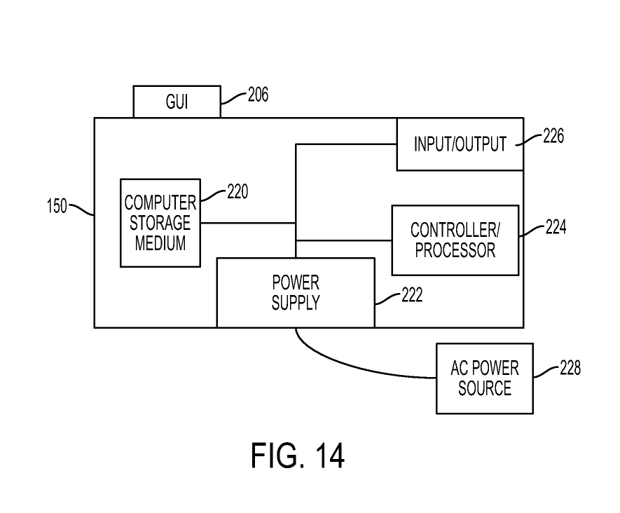

FIG. 11 is flowchart illustrating an exemplary computer-implemented method herein. In item 100, this method automatically analyzes different types of historical automobile parking violations within a predetermined geographic region using a computerized device to produce parking violation trends 102. For example, various statistical analyses can be performed to establish patterns of times, days of the week, seasons, events, etc., that may produce a larger amount or a smaller amount of parking violations. Once these parking violation trends 102 are established, they can be stored in a database so that they can be accessed at a future time. For example, the parking violation trends 102 could be stored in the non-volatile computer storage medium 220 that is shown in FIG. 14 below.

This method automatically predicts the numbers of parking violations that potentially could be issued during a plurality of predetermined work periods in item 104 based on the parking violation trends (using the computerized device). Specifically, the methods and systems herein utilize various models (such as the one illustrated above) in order to make predictions of what will occur in the future based upon what has occurred in the past. For example, if a certain event (or time of day during a certain day, or day of the week) produces unusually high parking violations, this same event can be used to predict future unusually high parking violations.

In item 106, the method automatically compares the actual number of parking violations issued during the predetermined work periods to the number of parking violations that potentially could be issued during the predetermined work periods, using the computerized device, to produce a parking violation issuance variance 108. This method also automatically identifies ones of the predetermined work periods in which parking violation citations could be increased (using the computerized device) to produce an opportunity report in item 110, and outputs the opportunity report from the computerized device in item 112.

For example, the predetermined work periods can comprise a portion of a workday (such as a certain time of day); a work day (such as Mondays); a work week (such as the last week of the month); a work month (such as December); and/or a work year. Therefore, with systems and methods herein, the analysis can identify any form of time period where opportunities for increased parking enforcement may exist.

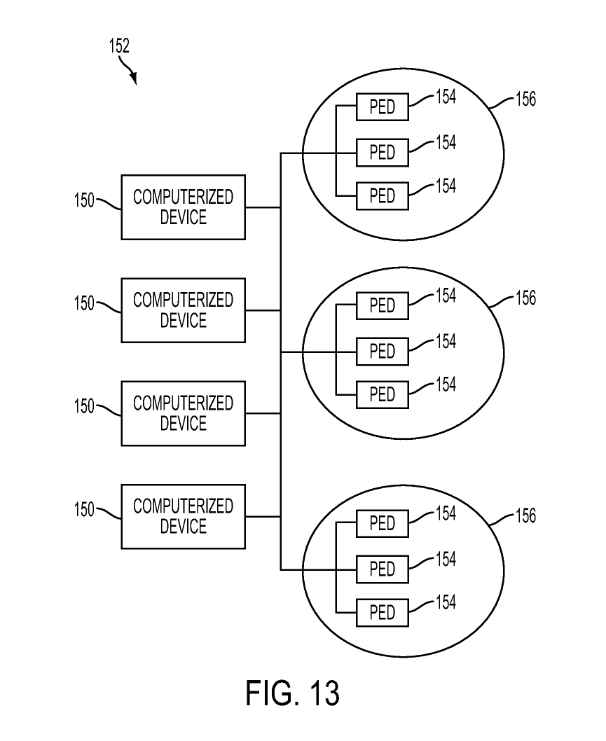

Further, the parking violation trends are specific to each different geographic region (such as those geographic regions 154 shown in FIG. 13, discussed below). Thus, one geographic region 154 can be the area for which a single parking enforcement officer is responsible. Alternatively, a geographic region 154 can be the entire geographic area for which a parking enforcement department is responsible. A “parking enforcement officer” can be, for example, a government police officer, a private parking lot employee, a government contractor, a “meter-maid”, etc. By utilizing different geographic regions, the systems and methods herein can identify increased parking enforcement opportunities for a single enforcement officer, for multiple officers, or for an entire parking enforcement department.

Also, the historical automobile parking violations may include only parking violation citations actually issued by a parking enforcement division, or the historical automobile parking violations can also (or only) include observed violations of parking regulations (independent of the parking violation citations actually issued by a parking enforcement division) or some combination of the two. Thus, the historical automobile parking violations data that is maintained within the database can be obtained from one source, or multiple sources. One such source is from actual parking violation citations issued by parking enforcement officers. Other external or independent sources include automated cameras, sensors, human observations, etc., which do not necessarily result in actual parking violation citations, but which nonetheless identify actual parking violations. Such external independent sources can be temporarily established within different geographic regions (for example as part of a management study) in order to create baseline values that are independent of actions of parking enforcement officers.

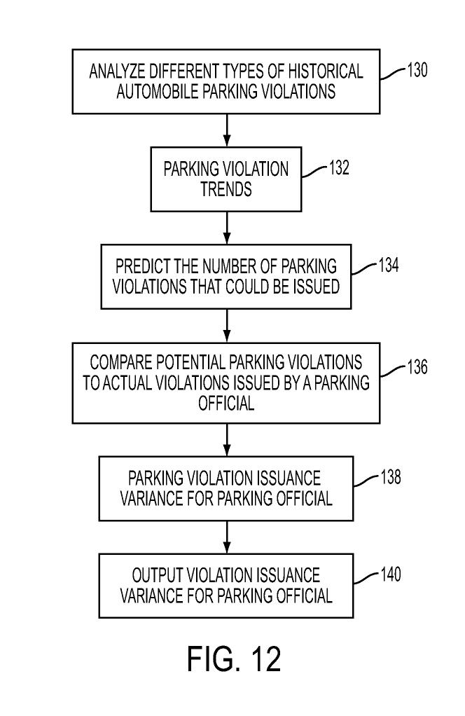

FIG. 12 illustrates another computer-implemented method herein that again automatically analyzes historical automobile parking violations within the predetermined geographic region using the computerized device (item 130) to produce parking violation trends 132. In item 134, this method automatically predicts the number of parking violations that potentially could be issued by at least one parking official during at least one predetermined work period based on the parking violation trends 132 (using the computerized device). In item 136, this method then automatically compares the actual number of parking violations issued by the one or more parking officials during the predetermined work period(s) to the number of parking violations that potentially could be issued by the parking official(s) during the predetermined work period (using the computerized device) to produce a parking violation issuance variance 138 for the parking official(s). This method then outputs the parking violation issuance variance 138 from the computerized device in item 140.

FIG. 13 illustrates a system embodiment herein that includes a plurality of automobile parking violation enforcement devices 154 (PED) 154 producing parking violation information within predetermined geographic regions 156. For example, the parking violation enforcement devices 154 can comprise automated parking meters, handheld parking violation citation issuing devices, or computer systems utilized by court agencies and vendors that process manually generated parking violation citations.

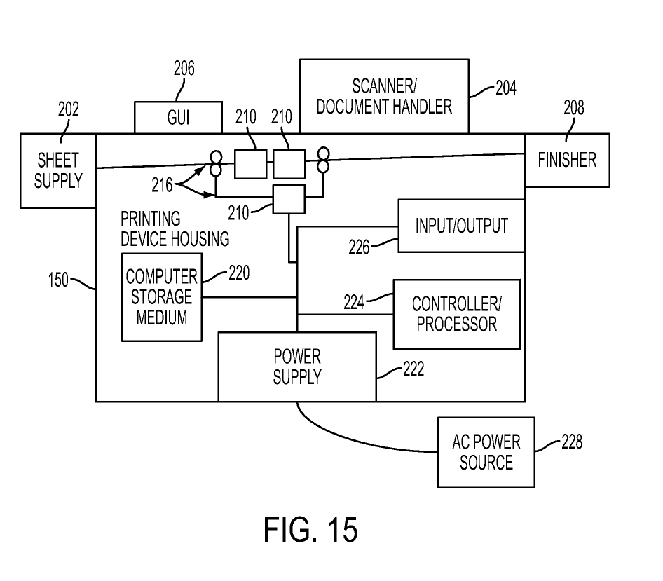

Further, one or more computerized devices 150 (each of which includes a communications device 226, shown in FIGS. 14 and 15 discussed below) are operatively connected to (e.g., directly or indirectly connected to) the parking violation enforcement devices 154 through a local area or wide area network 152. The communications device aggregates different types of the parking violation information that is combined into the historical automobile parking violations database, that is discussed above.

FIG. 14 illustrates one example of the computerized device 150, which can comprise, for example, a computer. FIG. 15 illustrates another example of the computerized device 150, which can comprise, for example, a printer, copier, multi-function machine, etc. Each such computerized device 150 includes a controller/processor 224, a graphic user interface assembly 206, and a communications port (input/output) 226 operatively connected to the processor 224 and to a computerized network external to the printing device.

The input/output device 226 is used for communications to and from each such computerized device 150. The processor 224 controls the various actions of each such computerized device 150. A non-transitory computer storage medium device 220 (which can be optical, magnetic, capacitor based, etc.) is readable by the processor 224 and stores data and instructions that the processor 224 executes to allow each such computerized device 150 to perform its various functions, such as those described herein.

Each such computerized device 150 has one or more functional components that operate on power supplied from the alternating current (AC) 228 by the power supply 222. The power supply 222 connects to an external alternating current power source 228 and converts the external power into the type of power needed by the various components.

If the computerized device 150 includes printing capabilities (FIG. 15) at least one marking device (printing engines) 210 is operatively connected to the processor 224, a media path 216 is positioned to supply sheets of media from a sheet supply 202 to the marking device(s) 210. After receiving various markings from the printing engine(s) 210, the sheets of media can optionally pass to a finisher 208 which can fold, staple, sort, etc., the various printed sheets. Also, such a printing computerized device 150 can include at least one accessory functional component (such as a scanner/document handler 204, sheet supply 202, finisher 208, etc.) that also operate on the power supplied from the external power source 228 (through the power supply 222).

As would be understood by those ordinarily skilled in the art, the computerized devices 150 shown in FIGS. 14 and 15 are only examples and the embodiments herein are equally applicable to other types of devices that may include fewer components or more components.

In such computerized devices 150, the processor 224 automatically analyzes the historical automobile parking violations within a predetermined geographic region 156 to produce parking violation trends. The processor 224 automatically predicts the numbers of parking violations that potentially could be issued during the plurality of predetermined work periods based on the parking violation trends. The processor 224 automatically compares the actual number of parking violations issued during the predetermined work periods to the number of parking violations that potentially could be issued during the predetermined work periods to produce a parking violation issuance variance, and the processor 224 automatically identifies ones of the predetermined work periods in which parking violation citations could be increased to produce an opportunity report. The printing engine 210 or the input/output device 226 can be used to output such an opportunity report.

With other systems herein, the processor 224 automatically predicts the number of parking violations that potentially could be issued by at least one parking official during at least one predetermined work period based on the parking violation trends, and the processor 224 automatically compares the actual number of parking violations issued by the one or more parking officials during the predetermined work period to the number of parking violations that potentially could be issued by the parking official(s) during the predetermined work period to produce a parking violation issuance variance for the parking official(s). The printing engine 210 or the input/output device 226 can be used to output the parking violation issuance variance from the computerized device.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

1. A computer-implemented method comprising:
automatically analyzing different types of historical automobile parking violations within a predetermined geographic region using a computerized device to produce parking violation trends;
automatically predicting numbers of parking violations that potentially could be issued during a plurality of predetermined work periods based on said parking violation trends using said computerized device;
automatically comparing an actual number of parking violations issued during said predetermined work periods to said number of parking violations that potentially could be issued during said predetermined work periods using said computerized device to produce a parking violation issuance variance;
automatically identifying ones of said predetermined work periods in which parking violation citations could be increased using said computerized device to produce an opportunity report; and
outputting said opportunity report from said computerized device.

2. The method according to claim 1, said predetermined work periods comprising a portion of a work day, a work day, a work week, a work month, and a work year.

3. The method according to claim 1, said parking violation trends being specific to each different geographic region.

4. The method according to claim 1, said historical automobile parking violations comprising parking violation citations issued by a parking enforcement division.

5. The method according to claim 1, said historical automobile parking violations comprising observed violations of parking regulations independent of parking violation citations issued by a parking enforcement division.

6. A computer-implemented method comprising:
automatically analyzing historical automobile parking violations within a predetermined geographic region using a computerized device to produce parking violation trends;
automatically predicting a number of parking violations that potentially could be issued by at least one parking official during at least one predetermined work period based on said parking violation trends using said computerized device;
automatically comparing an actual number of parking violations issued by said parking official during said predetermined work period to said number of parking violations that potentially could be issued by said parking official during said predetermined work period using said computerized device to produce a parking violation issuance variance for said parking official; and
outputting said parking violation issuance variance from said computerized device.

7. The method according to claim 6, said predetermined work period comprising a portion of a work day, a work day, a work week, a work month, and a work year.

8. The method according to claim 6, said parking violation trends being specific to each different geographic region.

9. The method according to claim 6, said historical automobile parking violations comprising parking violation citations issued by a parking enforcement division employing said parking official.

10. The method according to claim 6, said historical automobile parking violations comprising observed violations of parking regulations independent of parking violation citations issued by a parking enforcement division employing said parking official.

11. A system comprising:
a plurality of automobile parking violation enforcement devices producing parking violation information;
a communications device operatively connected to said parking violation enforcement devices, said communications device aggregating different types of said parking violation information into historical automobile parking violations;
a processor operatively connected to said communications device, said processor automatically analyzing said historical automobile parking violations within a predetermined geographic region to produce parking violation trends, said processor automatically predicting numbers of parking violations that potentially could be issued during a plurality of predetermined work periods based on said parking violation trends, said processor automatically comparing an actual number of parking violations issued during said predetermined work periods to said number of parking violations that potentially could be issued during said predetermined work periods to produce a parking violation issuance variance, and said processor automatically identifying ones of said predetermined work periods in which parking violation citations could be increased to produce an opportunity report; and
an input/output device operatively connected to said processor, said input/output device outputting said opportunity report.

12. The system according to claim 11, said predetermined work periods comprising a portion of a work day, a work day, a work week, a work month, and a work year.

13. The system according to claim 11, said parking violation trends being specific to each different geographic region.

14. The system according to claim 11, said historical automobile parking violations comprising parking violation citations issued by a parking enforcement division.

15. The system according to claim 11, said historical automobile parking violations comprising observed violations of parking regulations independent of parking violation citations issued by a parking enforcement division.

16. A system comprising:
a plurality of automobile parking violation enforcement devices producing parking violation information;
a communications device operatively connected to said parking violation enforcement devices, said communications device aggregating different types of said parking violation information into historical automobile parking violations;
a processor operatively connected to said communications device, said processor automatically analyzing historical automobile parking violations within a predetermined geographic region to produce parking violation trends, said processor automatically predicting a number of parking violations that potentially could be issued by at least one parking official during at least one predetermined work period based on said parking violation trends, and said processor automatically comparing an actual number of parking violations issued by said parking official during said predetermined work period to said number of parking violations that potentially could be issued by said parking official during said predetermined work period to produce a parking violation issuance variance for said parking official; and
an input/output device operatively connected to said processor, said input/output device outputting said parking violation issuance variance.

17. The system according to claim 16, said predetermined work period comprising a portion of a work day, a work day, a work week, a work month, and a work year.

18. The system according to claim 16, said parking violation trends being specific to each different geographic region.

19. The system according to claim 16, said historical automobile parking violations comprising parking violation citations issued by a parking enforcement division employing said parking official.

20. The system according to claim 16, said historical automobile parking violations comprising observed violations of parking regulations independent of parking violation citations issued by a parking enforcement division employing said parking official.
